(19) United States
(12) Patent Application Publication
(10) Pub. No.: US 2024/0192732 A1
(43) Pub. Date: Jun. 13, 2024

(54) MAGNETIC PORT COVERS FOR COMPUTING DEVICES

(71) Applicant: Hewlett-Packard Development Company, L.P., Spring, TX (US)

(72) Inventors: Po-Ying Chih, Taipei City (TW); Chien-Wei Chen, Taipei City (TW); Chi-Wei Ting, Taipei City (TW); Chun-Hua Huang, Taipei City (TW); Chien Fa Huang, Taipei City (TW)

(73) Assignee: Hewlett-Packard Development Company, L.P., Spring, TX (US)

(21) Appl. No.: 18/555,227

(22) PCT Filed: Jun. 29, 2021
(86) PCT No.: PCT/US2021/039485

§ 371 Date: Oct. 12, 2023

(51) Int. Cl. G06F 1/16; G01R 33/07; G06F 1/18; G06F 21/31; G06F 21/73

(52) U.S. Cl. CPC G06F 1/1656; G01R 33/072; G06F 1/182; G06F 21/31; G06F 21/73

(57) ABSTRACT

In example implementations, an apparatus is provided. The apparatus includes a plurality of ports, a magnetic field sensor, a magnetic port cover, and a processor. A subset of ports of the plurality of ports are deactivated and covered with the magnetic port cover. The magnetic field sensor is coupled to each one of the plurality of ports. The processor is communicatively coupled to the magnetic field sensor. The processor is to detect removal of the magnetic port cover from a deactivated port of the subset of ports that are deactivated via a signal from the magnetic field sensor of the deactivated port and generate notification in response to the magnetic port cover being removed to notify a user to replace the magnetic port cover on the deactivated port.

### BACKGROUND

Computing devices are used to execute various applications. The computing devices may include different types of interfaces and ports to connect to external peripheral devices. For example, the interfaces may be used to connect to external memory devices, connect to an external display device, connect to a printing device, connect to a docking station, and the like. The external peripheral devices may add functionality to the computing device.

### BRIEF DESCRIPTION OF THE DRAWINGS

FIG. 1 is a block diagram of an example computing device having magnetic port covers of the present disclosure;

FIG. 2 is another block diagram of an example security sleeve and port of the computing device of the present disclosure;

FIG. 3 is a block diagram of the computing device to detect the magnetic port covers based on a status of ports of the computing device of the present disclosure;

FIG. 4 is a flow chart of an example method to control operation of a port on a computing device with detection of magnetic port covers of the present disclosure; and

FIG. 5 is an example non-transitory computer readable storage medium storing instructions executed by a processor to execute control operation of a port on a computing device with detection of magnetic port covers of the present disclosure.

### DETAILED DESCRIPTION

Examples described herein provide a magnetic port cover for computing devices and a method for controlling operation of a port using the magnetic port covers. As discussed above, computing devices may include different types of interfaces and ports to connect to external peripheral devices. For example, the interfaces may be used to connect to external memory devices, connect to an external display device, connect to a printing device, connect to a docking station, and the like. The external peripheral devices may add functionality to the computing device.

However, access to these ports may pose a security risk to the computing device. For example, malware and/or viruses may be passed onto the computing device from applications downloaded from external memory devices. In other examples, some users may not be authorized to connect to certain peripheral devices. Thus, some enterprises may want to control which ports on an issued computing device can be accessed by user. In other examples, some public computing devices (e.g., in a public library or public computer café, and the like) may want to prevent users from accessing the ports on the computing device for security reasons.

The present disclosure provides a magnetic port cover that may allow ports on the computing device to be selectively blocked. For example, an information technology (IT) administrator may define which ports are to be deactivated on the computing device by changes to settings in the basic input/output system (BIOS) of the computing device. The computing device may then expect magnetic port covers to be placed over the deactivated ports to prevent usage of the ports. If the magnetic port cover is removed from a deactivated port, the computing device may generate and display a warning message to the user. The warning message may indicate that a particular port has been deactivated and to replace the magnetic cover. Other security measures may also be activated when the magnetic cover is removed, such as blocking the activation of any executable files until the magnetic cover is replaced, entering an administrator username and password to use the computing device, and the like.

In an example, the magnetic cover may attach to metal placed around an opening of a security sleeve associated with a port on the computing device. The magnetic cover may allow ports to be selectively blocked while using the security sleeve. The computing device may be modified to include a hall sensor near each port. Thus, when a port is deactivated, the hall sensor may be used to detect the magnetic field of the magnetic cover when the magnetic cover is attached. When the hall sensor no longer detects the magnetic field, a signal may be generated to indicate that the magnetic cover has been removed. As a result, the present disclosure provides a mechanical and software solution to selectively controlling ports on a computing device.

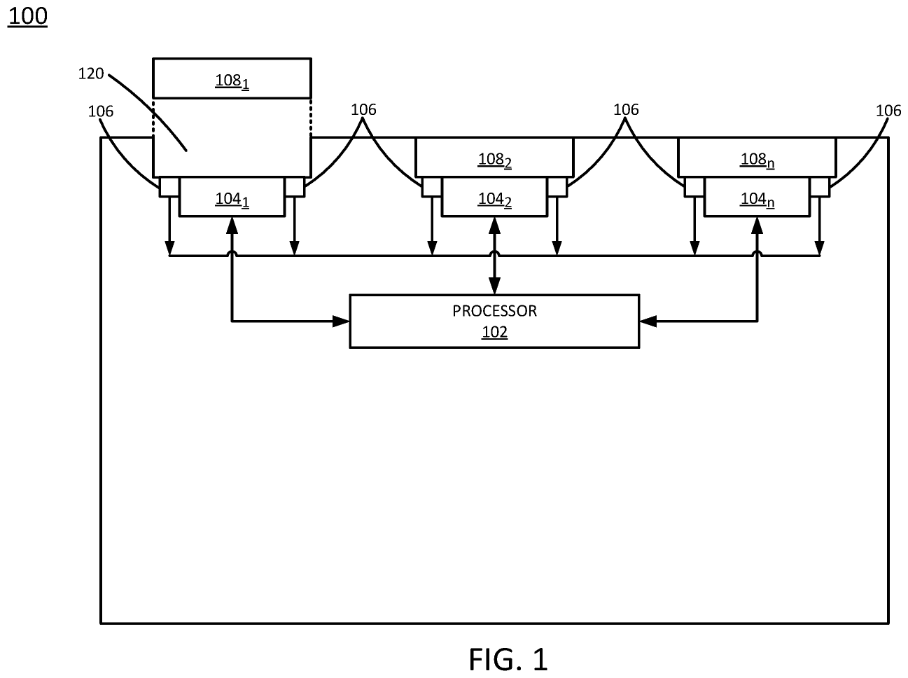

FIG. 1 illustrates an example computing device 100 of the present disclosure. In an example, the computing device 100 may include a plurality of ports 1041 to 104n (hereinafter also referred to individually as a port 104 or collectively as ports 104). The ports 104 may be any type of port that provides an opening to an interface. The ports 104 may be communicatively coupled to a processor 102. When an external device is connected to a port 104, the processor 102 may communicate with the external device to exchange information or control operation of the external device.

In an example, the ports 104 may have a variety of different sizes and styles. For example, the ports 104 may include a universal serial bus (USB) interface, a USB type-C interface, a thunderbolt interface, high definition media interface (HDMI) port, a mini display port, and the like.

In an example, a magnetic field sensor 106 may be located adjacent to each one of the ports 104. Although each port 104 is shown with two magnetic field sensors 106, it should be noted that a single magnetic field sensor 106 may be located around the ports 104. In an example, two magnetic field sensors are deployed to ensure that magnetic port covers 1081 to 108n (hereinafter also referred to individually as a magnetic port cover 108 or collectively as magnetic port covers 108) cover the entire respective opening of the respective ports 1041 to 104n.

For example, with a single magnetic field sensor 106, the magnetic port cover 108 may be rotated to reveal the respective port 104. The magnetic field sensor 106 may still detect the magnetic field created by the magnetized magnetic port cover 108, even though the magnetic port cover 108 has been essentially removed from the respective port 104.

In an example, the magnetic field sensors 106 and the ports 104 may be located in a recess 120. The recess 120 may have a depth and shape that are similar to a thickness and shape of the magnetic port cover 108. The recess 120 may also prevent a user from rotating the magnetic port cover 108 to access the port 104 and trying to “trick” the magnetic field sensor 106.

In an example, the magnetic field sensor 106 may be any type of sensor that can detect a magnetic field. In an example, the magnetic field sensor 106 may be a hall sensor.

In an example, the location and/or sensitivity of the magnetic field sensor 106 may be adjusted or fine-tuned with the material of the magnet used in the magnetic port cover 108. For example, the location, depth, and/or sensitivity of the magnetic field sensor 106 may be positioned to be able to detect the magnetic port cover 108 when the magnetic port cover 108 is in contact with metal around the port 104 or placed flush within the recess 120. This may prevent users from applying a powerful magnet over the magnetic port cover 108 before removing the magnetic port cover 108. The magnetic field sensor 106 may detect the magnetic field of the powerful magnet even when the magnetic port cover 108 is removed if the location of the magnetic field sensor 106 is not fine-tuned.

In an example, each port 1041 to 104, may be covered by a respective magnetic port cover 1081 to 108n. For example, the magnetic port cover 1081 may cover the port 1041, the magnetic port cover 1082 may cover the port 1042, and so forth.

In an example, a user may deactivate certain ports 104. As noted above, some computing devices 100 may be deployed in public areas or may be issued to employees with the ports 104 deactivated to prevent tampering or connections to external devices and/or memory devices. The magnetic port covers 108 may be placed over the ports 104. The magnetic field sensor 106 may detect the presence of the magnetic port covers 108.

In an example, when a magnetic port cover 108 is removed, the magnetic field sensor 106 may send a signal to the processor 102. For example, in FIG. 1, the magnetic port cover 1081 has been removed from the port 1041. As a result, the magnetic field sensor 106 may generate a signal indicating that the magnetic port cover 1081 has been removed.

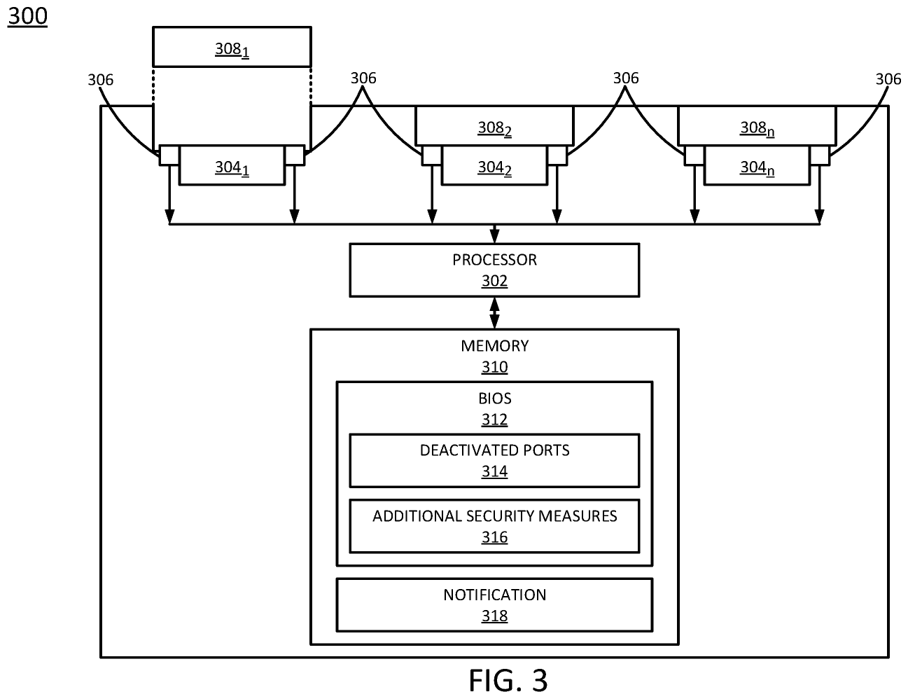

The processor 102 may know which ports are deactivated. A list of deactivated ports may be stored in memory, as illustrated by example in FIG. 3 and discussed below. If the magnetic port cover 1081 is removed from the port 1041 that has been deactivated, then the processor 102 may generate a notification in response to the magnetic port cover 1081 being removed. The notification may instruct a user to replace the magnetic port cover 1081 on the deactivated port 1041.

In an example, additional security measures may be activated if the magnetic port cover 1081 is not replaced within a predetermined amount of time. The additional security measures may be stored in a basic input/output system (BIOS) settings. An example of the additional security measures are discussed in further details below with reference to FIG. 3.

It should be noted that the computing device 100 has been simplified for ease of explanation and may include additional hardware components that are not illustrated in FIG. 1. For example, the computing device 100 may include a display, input/output devices (e.g., a keyboard, a mouse, a touch screen display, and the like), a graphics processor, a power supply, communication interfaces (e.g., an Ethernet jack or a wireless network card), and the like.

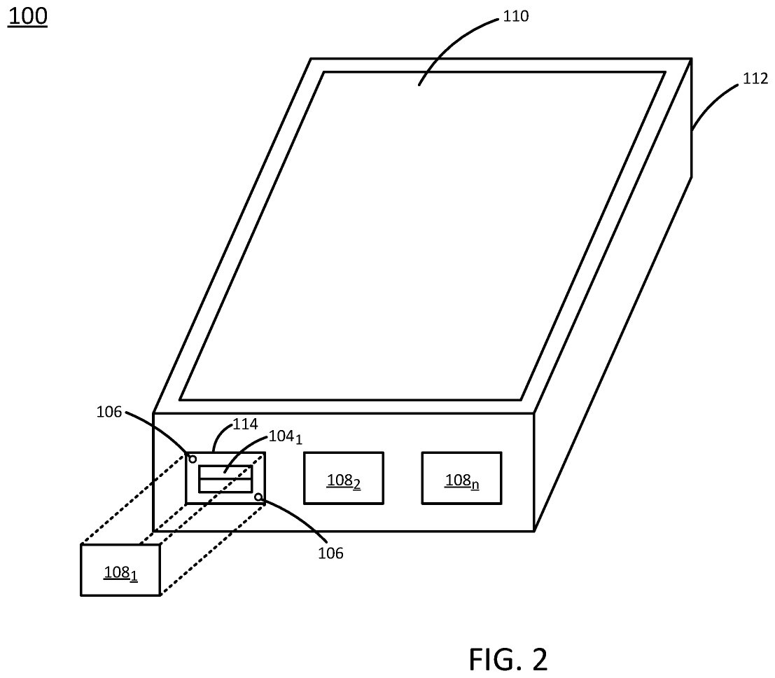

FIG. 2 illustrates a block diagram of an example security sleeve 112 that may include the magnetic port covers 108. In an example, the security sleeve 112 may be a soft cover fabricated from nylon, polyester, plastic, and the like. The security sleeve 112 may be placed around the outer perimeter of a housing 110 of the computing device 100.

The security sleeve 112 may have openings that correspond to locations of the ports 104 on the housing 110 of the computing device 100. In an example, the magnetic port covers 108 may be fabricated from a magnetic material or may include a magnet. The magnet may be adhered to a back side or a portion of the back side of the magnetic port cover 108.

In an example, a metal portion 114 may be deployed around an opening of the security sleeve 112 or around the ports 104. The metal portion 114 may have a size that corresponds to a size of the magnetic port cover 108 or that is large enough to contact the magnet of the magnetic port cover 108. The metal portion 114 may be any type of metal that can attract a magnet.

In an example, magnetic field sensors 106 may be located on opposite corners of the port 104. As noted above, deploying at least two magnetic field sensors 106 for each port 104 may ensure that removal of the magnetic port cover 108 can be detected. For example, magnetic field sensors 106 may be located in an upper corner and a bottom corner on an opposite side (e.g., upper left hand corner and bottom right hand corner). With such an arrangement, the magnetic port cover 108 cannot be removed or rotated without detection by the magnetic field sensor 106.

FIG. 3 illustrates a block diagram of a computing device 300 that can detect the magnetic port covers based on a status of ports of the computing device 300. In an example, the computing device 300 may include ports 3041 to 304n (hereinafter also referred to individually as a port 304 or collectively as ports 304). The ports may be similar to the ports 104. The ports 304 may be communicatively coupled to a processor 302.

In an example, the computing device 300 may also include magnetic field sensors 306 near, adjacent to, or around the ports 304. Although each port 304 is illustrated with two magnetic field sensors, it should be noted that any number of magnetic field sensors 306 may be deployed (e.g., one or more than two).

In an example, each port 3041 to 304n may be covered by a respective magnetic port cover 3081 to 308n (hereinafter also referred to individually as a magnetic port cover 308 or collectively as magnetic port covers 308). For example, the magnetic port cover 3081 may cover the port 3041, the magnetic port cover 3082 may cover the port 3042, and so forth.

In an example, the computing device 300 may include a memory 310. The memory 310 may be communicatively coupled to the processor 302. The memory 310 may store instructions that are executed by the processor 302 to perform the functions described herein.

In an example, the memory 310 may be any type of non-transitory computer readable medium. For example, the memory 310 may be a hard disk drive, a solid state drive, a random access memory (RAM), a read only memory (ROM), and the like. Although a single memory 310 is illustrated, it should be noted that the memory 310 may include separate memory devices. For example, one memory 310 may be accessed by a user and a second memory 310 may be inaccessible by a user.

In an example, the memory 310 may store a BIOS 312. As used herein, a BIOS refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of the computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

In an example, the BIOS 312 may store a list of deactivated ports 314 and additional security measures 316. For example, an information technology (IT) administrator for an enterprise may deactivate some or all of the ports 304. For example, the port 3041 may be an HDMI interface and ports 3042 to 304n may be USB interfaces. The IT administrator may allow port 3041 to be accessed to allow the computing device 300 to be connected to an external monitor. However, the ports 3042 to 304, may be deactivated in the BIOS 312 to prevent the user from downloading malicious code via external memory devices that could connect to the ports 3042 to 304n.

The processor 302 may monitor whether the magnetic field sensors 306 associated with the ports 3042 to 304n detect a magnetic field. Detection of a magnetic field may indicate that the magnetic port covers 3082 to 308n are covering the respective ports 3042 to 304n.

However, a user may attempt to remove the magnetic port cover 3082 to access a USB interface in the port 3042. The magnetic field sensor 306 may no longer detect a magnetic field and may send a signal to the processor 302 indicating that the magnetic port cover 3082 has been removed. The processor 302 may check to see if the port 3042 is a deactivated port in the list of deactivated ports 314. If the port 3042 is deactivated, the processor 302 may generate a notification 318 stored in the memory 310.

In an example, the notification 318 may be a pop-up message or other type of indication to notify a user that the magnetic port cover 3082 associated with the port 3042 has been removed. The notification 318 may instruct the user to replace the magnetic port cover 3082.

In an example, the user may be given a predefined amount of time to replace the magnetic port cover 3082. For example, the notification 318 may include a countdown timer of the predefined amount of time. In an example, the predefined amount of time may be an amount of time that is sufficient to replace the magnetic port cover 308, but insufficient to connect an external device or memory and download or copy any files. For example, the predefined amount of time may be 15 seconds, 30 seconds, a minute, and the like.

In an example, if the predefined amount of time expires, the additional security measures 316 stored in the BIOS 312 may be implemented. For example, the additional security measures 316 may disable all drivers for any connected devices. The additional security measures 316 may prevent access to the memory 310 (e.g., files cannot be transferred to the memory 310 or files cannot be copied from the memory 310). The additional security measures 316 may prevent execution of certain file extensions of any applications (e.g., .exe file extensions).

In an example, the additional security measures 316 may lock down the entire computing device 300. For example, the computing device 300 may become inoperable, or operation of the processor 302 may be blocked, until an administrator log-in and password is received or the magnetic port cover 308 is replaced.

In an example, the IT administrator may modify the ports 304 that are listed in the list of deactivated ports 314. For example, at a later time, the IT administrator may want to block the port 3041 as well. Thus, the IT administrator may enter a username and password to access the list of deactivated ports 314 in the BIOS 312. The IT administrator may make changes to the BIOS 312 to add the port 3041 to the list of deactivated ports 314. The BIOS 312 may activate the magnetic field sensors 306 associated with the ports 3041. The magnetic port cover 3081 may be placed over the port 3041 and the magnetic field created by the magnets on the magnetic port cover 3081 may be detected by the magnetic field sensors 306.

Thus, the present disclosure may provide a security sleeve that includes openings that may allow for individual magnetic port covers to be applied to desired ports of a computing device. As a result, unlike previous security sleeves that would cover all ports, the present disclosure allows selective deactivation and covering of ports. In addition, the ports that are deactivated or activated can be changed, and the corresponding ports can be covered or uncovered, as desired.

In addition, the magnetic field sensors may allow the computing device to monitor if any of the magnetic port covers are removed. When magnetic port covers are removed, a notification may be generated and/or additional security measures may be activated, as described above.

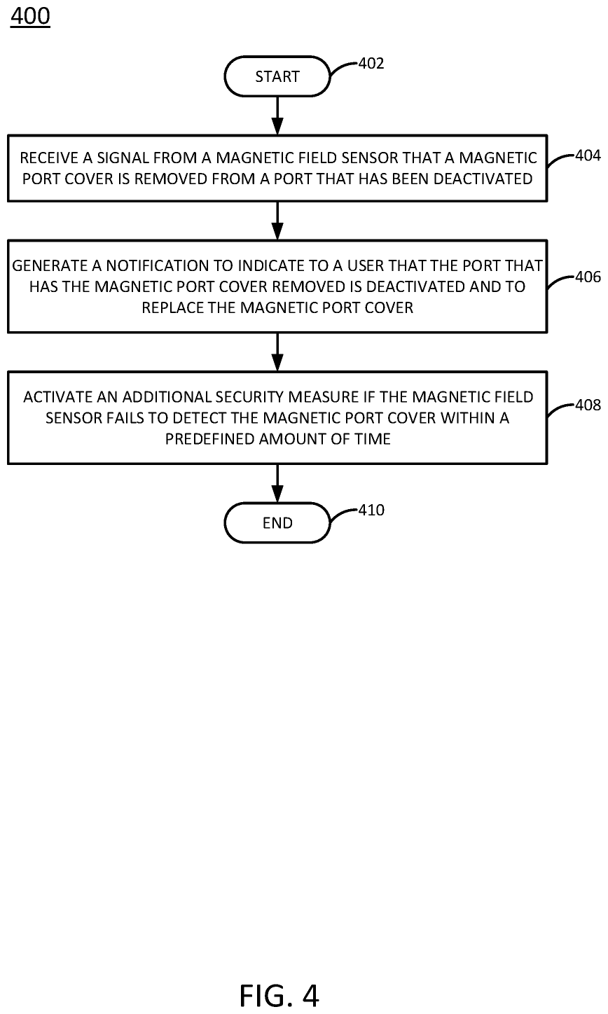

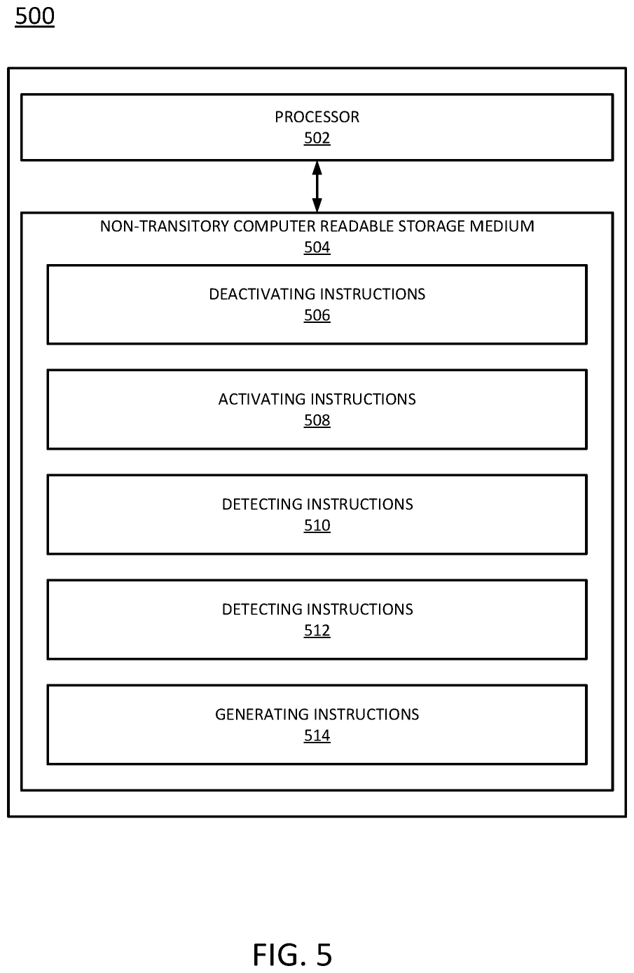

FIG. 4 illustrates a flow diagram of an example method 400 for controlling operation of a port on a computing device with detection of magnetic port covers of the present disclosure. In an example, the method 400 may be performed by the computing device 100, 300, or the apparatus 500 illustrated in FIG. 5, and described below, and described below.

At block 402, the method 400 begins. At block 404, the method 400 receives a signal from a magnetic field sensor that a magnetic port cover is removed from a port that has been deactivated. For example, the magnetic field sensor may be a hall sensor that can detect the presence of a magnetic field. When the magnetic port cover is coupled to a metal portion around an opening of a security sleeve or around the port, the hall sensor may detect the magnetic field generated by a magnet of the magnetic port cover. When the magnetic port cover is removed, the hall sensor may no longer detect a magnetic field. In response, a signal may be generated indicating that no magnetic field is detected, which can be translated by a processor of the computing device into an indication that the magnetic port cover has been removed.

At block 406, the method 400 generates a notification to indicate to a user that the port that has the magnetic port cover removed is deactivated and to instruct the user to replace the magnetic port cover. The notification may be shown to the user on a display of the computing device or on an external display connected to the computing device. The notification may remind the user that the port the user is trying to access has been deactivated and to replace the magnetic port cover.

At block 408, the method 400 activates an additional security measure if the magnetic field sensor fails to detect the magnetic port cover within a predefined amount of time. In an example, the notification may include a countdown timer from the predefined amount of time. When the countdown timer expires, the additional security measure may be activated.

For example, the additional security measures may disable all drivers for any connected devices. The additional security measures may prevent access to the memory (e.g., files cannot be transferred to the memory or files cannot be copied from the memory). The additional security measures may prevent execution of certain file extensions of any applications (e.g., all executable (.exe) file extensions).

In an example, the additional security measures may lock down the entire computing device. For example, the computing device may become inoperable, or operation of the processor may be blocked, until an administrator log-in and password is received or the magnetic port cover is replaced.

Once the additional security measures are activated, an IT username and password may be used to reset the magnetic field sensors for the port. The magnetic port cover may be replaced and the computing device may return to normal operation. At block 410, the method 400 ends.

FIG. 5 illustrates an example of an apparatus 500. In an example, the apparatus 500 may be the computing device 100. In an example, the apparatus 500 may include a processor 502 and a non-transitory computer readable storage medium 504. The non-transitory computer readable storage medium 504 may include instructions 506, 508, 510, 512, and 514 that, when executed by the processor 502, cause the processor 502 to perform various functions.

In an example, the instructions 506 may include deactivating instructions 506. For example, the instructions 506 may deactivate a port via a basic input/output system (BIOS) of the computing device. For example, the BIOS may store a list of ports that are deactivated.

The instructions 508 may include activating instructions. For example, the instructions 508 may activate a hall sensor associated with the port that is deactivated. For example, the hall sensor may be used to detect a magnetic field generated by a magnet of a magnetic port cover.

The instructions 510 may include detecting instructions. For example, the instructions 512 may detect placement of a magnetic port cover on the port that is deactivated via the hall sensor. For example, when the magnetic field is detected by the hall sensor, the computing device may detect that the magnetic port cover is in place over the port.

The instructions 512 may include detecting instructions. For example, the instructions 512 may detect removal of the magnetic port cover via the hall sensor. At some point in time, a user may attempt to access a port that has been deactivated. The user may remove the magnetic port cover that covers the deactivated port. Removal of the magnetic port cover may be detected by the hall sensor when the magnetic field from the magnetic port cover is no longer detected.

The instructions 514 may include generating instructions. For example, the instructions 514 may generate a notification to replace the magnetic port cover in response to removal of the magnetic port cover being detected. In an example, additional security measures may be activated at least until the magnetic port cover is replaced and detected by the hall sensor.

In an example, the non-transitory computer readable storage medium 504 may include further instructions to make changes to the list of ports that are deactivated. For example, an administrator username and password may be received. Changes to the BIOS to deactivate a second port may be received. A second hall sensor associated with the second port may be activated. Placement of a second magnetic port cover on the port that is deactivated may be detected via the second hall sensor. The computing device may monitor the presence of the second magnetic port cover and the first magnetic port cover.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a plurality of ports, wherein a subset of the ports is deactivated;
a magnetic field sensor coupled to each one of the plurality of ports;
a magnetic port cover coupled to each one of the subset of ports that is deactivated; and
a processor communicatively coupled to the magnetic field sensor, wherein the processor is to:
detect removal of the magnetic port cover from a deactivated port of the subset of ports that is deactivated via a signal from the magnetic field sensor of the deactivated port; and
generate a notification in response to the magnetic port cover being removed to notify a user to replace the magnetic port cover on the deactivated port.

2. The apparatus of claim 1, further comprising:
a security sleeve enclosing the apparatus, wherein the security sleeve comprises an opening that corresponds to a location of each port of the plurality of ports, wherein a portion of the opening includes metal to connect to a magnet of the magnetic port cover.

3. The apparatus of claim 1, wherein the deactivated port with the magnetic port cover removed is identified based on the magnetic port cover that is assigned to the deactivated port.

4. The apparatus of claim 1, wherein the magnetic field sensor comprises a hall sensor.

5. The apparatus of claim 1, wherein the signal from the magnetic field sensor comprises a signal to indicate an absence of a magnetic field.

6. The apparatus of claim 1, further comprising:
a memory communicatively coupled to the processor, wherein the memory is to store settings in a basic input/output system (BIOS) that define the subset of ports of the plurality of ports that are deactivated.

7. A method, comprising:
receiving, by a processor, a signal from a magnetic field sensor that a magnetic port cover is removed from a port that has been deactivated;
generating, by the processor, a notification to indicate to a user that the port that has the magnetic port cover removed is deactivated and to replace the magnetic port cover; and
activate, by the processor, an additional security measure when the magnetic field sensor fails to detect the magnetic port cover within a predefined amount of time.

8. The method of claim 7, wherein the port is deactivated via changes to settings of a basic input/output system (BIOS).

9. The method of claim 7, wherein the magnetic field sensor comprises a hall sensor located along a perimeter of the port at a location that corresponds to a location of a magnet of the magnetic port cover.

10. The method of claim 7, wherein the additional security measure comprises blocking execution of any executable file extensions.

11. The method of claim 7, wherein the additional security measure comprises blocking operation of the processor until the magnetic port cover is replaced on the port that has been deactivated.

12. The method of claim 7, wherein the additional security measure comprises blocking operation of the processor until an administrator username and password are received.

13. A non-transitory computer readable storage medium encoded with instructions, when executed, cause a processor of a computing device to:
deactivate a port via a basic input/output system (BIOS) of the computing device;
activate a hall sensor associated with the port that is deactivated;
detect placement of a magnetic port cover on the port that is deactivated via the hall sensor;
detect removal of the magnetic port cover via the hall sensor; and
generate a notification to replace the magnetic port cover in response to the removal of the magnetic port cover being detected.

14. The non-transitory computer readable storage medium of claim 13, further comprising instructions to cause the processor to:
receive an administrator username and password;
receive changes to the BIOS to deactivate a second port;
activate a second hall sensor associated with the second port that is deactivated; and
detect placement of a second magnetic port cover on the second port that is deactivated via the second hall sensor.

15. The non-transitory computer readable storage medium of claim 13, further comprising instructions to cause the processor to:
activate an additional security measure until the magnetic port cover is replaced and detected by the hall sensor.
